(19) United States
(12) Patent Application Publication
(10) Pub. No.: US 2018/0359408 A1
(43) Pub. Date: Dec. 13, 2018

(54) IMAGE TRANSMISSION CONTROL APPARATUS, IMAGE TRANSMISSION SYSTEM, IMAGE TRANSMISSION CONTROL METHOD AND STORAGE MEDIUM

(71) Applicant: CASIO COMPUTER CO., LTD., Tokyo (JP)

(72) Inventors: Kenji Iwamoto, Tokyo (JP); Hitoshi Tanaka, Tokyo (JP)

(73) Assignee: CASIO COMPUTER CO., LTD., Tokyo (JP)

(21) Appl. No.: 16/001,705

(22) Filed: Jun. 6, 2018

(30) Foreign Application Priority Data
Jun. 9, 2017 (JP) 2017-114622

(51) Int. Cl. H04N 5/232; H04N 5/76; G08C 17/02

(52) U.S. Cl. CPC H04N 5/23206; H04N 5/76; G08C 2201/32; H04N 5/23245; G08C 17/02

(57) ABSTRACT

When sensor information acquired from various sensors matches an imaging factor set by a user, a sensor unit transmits a shutter trigger to a remote controller. After receiving the shutter trigger, the remote controller transmits the shutter trigger to a digital camera. Then, when the shutter trigger is received during an operation in an interval imaging mode, the digital camera records a still image or a short moving image in response to the reception of the shutter trigger and stores the image as an unsent image while continuing the operation in the interval imaging mode. Then, after the end of the interval imaging mode, the digital camera transmits all unsent images to a portable wireless communication device.

### CROSS-REFERENCE TO RELATED APPLICATION

This application is based upon and claims the benefit of priority from the prior Japanese Patent Application No. 2017-114622, filed Jun. 9, 2017, the entire contents of which are incorporated herein by reference.

### BACKGROUND OF THE INVENTION

### 1. Field of the Invention

The present invention relates to an image transmission control apparatus, an image transmission system, an image transmission control method and a storage medium.

### 2. Description of the Related Art

As described in Japanese Patent Application Laid-Open (Kokai) Publication No. 2002-342465, there is a technique in which, every time a user captures a desired image with a digital camera, the image captured in response to the user's imaging instruction is immediately transmitted to a server computer on the Internet.

However, the images acquired in the image capturing include images that are not required to be immediately transmitted and checked after being captured. Accordingly, the technique where all captured images are immediately transmitted has a problem in that the transmission processing disadvantageously places a heavy load.

An object of the present invention is to improve convenience in image transmission and check processing.

### SUMMARY OF THE INVENTION

In accordance with one aspect of the present invention, there is provided a communication section; a detection section which detects a recording instruction signal; and a control section which controls to perform a recording operation for recording an image when the detection section has detected the recording instruction signal, and controls the communication section as to whether or not to transmit the image to outside of the image transmission control apparatus, based on an occurrence condition of the recording instruction signal.

In accordance with another aspect of the present invention, there is provided an image transmission system constituted by an imaging device and an external device, wherein the external device includes a first communication section and a first control section which judges whether an external environment has satisfied a specific condition and controls the first communication section to transmit a recording instruction signal when a judgment is made that the external environment has satisfied the specific condition, and wherein the imaging device includes an imaging section, a second communication section, and a second control section which (i) judges whether the second communication section has received the recording instruction signal during an operation in a predetermined recording mode, (ii) controls to perform a recording operation for recording an image in response to the recording instruction signal while maintaining the predetermined recording mode, when a judgment is made that the second communication section has received the recording instruction signal, and (iii) controls the second communication section to transmit the recorded image to outside of the imaging device after the recording operation.

In accordance with another aspect of the present invention, there is provided an image transmission control method comprising: a detection step of detecting a recording instruction signal; a recording operation step of causing an imaging section to perform a recording operation for recording an image when the recording instruction signal is detected in the detection step; and a control step of controlling a communication section as to whether or not to transmit the image based on an occurrence condition of the recording instruction signal.

In accordance with another aspect of the present invention, there is provided a non-transitory computer-readable storage medium having stored thereon a program that is executable by a computer in an image transmission apparatus to actualize functions comprising: detection processing for detecting a recording instruction signal; recording operation processing for causing an imaging section to perform a recording operation for recording an image when the recording instruction signal is detected by the detection processing; and control processing for controlling a communication section as to whether or not to transmit the image based on an occurrence condition of the recording instruction signal.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing the structure of an image transmission system according to an embodiment of the present invention;

FIG. 2 is a block diagram showing the structure of a sensor unit 10 according to the present embodiment;

FIG. 3 is a block diagram showing the structure of a remote controller 20 according to the present embodiment;

FIG. 4 is a block diagram showing the structure of a digital camera 30 according to the present embodiment;

FIG. 5 is a conceptual diagram showing an example of imaging factors that can be set in the sensor unit 10 according to the present embodiment;

FIG. 6 is a flowchart for describing the operation of the sensor unit 10 according to the present embodiment;

FIG. 7 is a flowchart for describing the operation of the remote controller 20 according to the present embodiment; and

FIG. 8 is a flowchart for describing the operation of the digital camera 30 according to the present embodiment.

### DETAILED DESCRIPTION OF THE PREFERRED EMBODIMENTS

Embodiments of the present invention will hereinafter be described with reference to the drawings.

### A. Structure of Embodiment

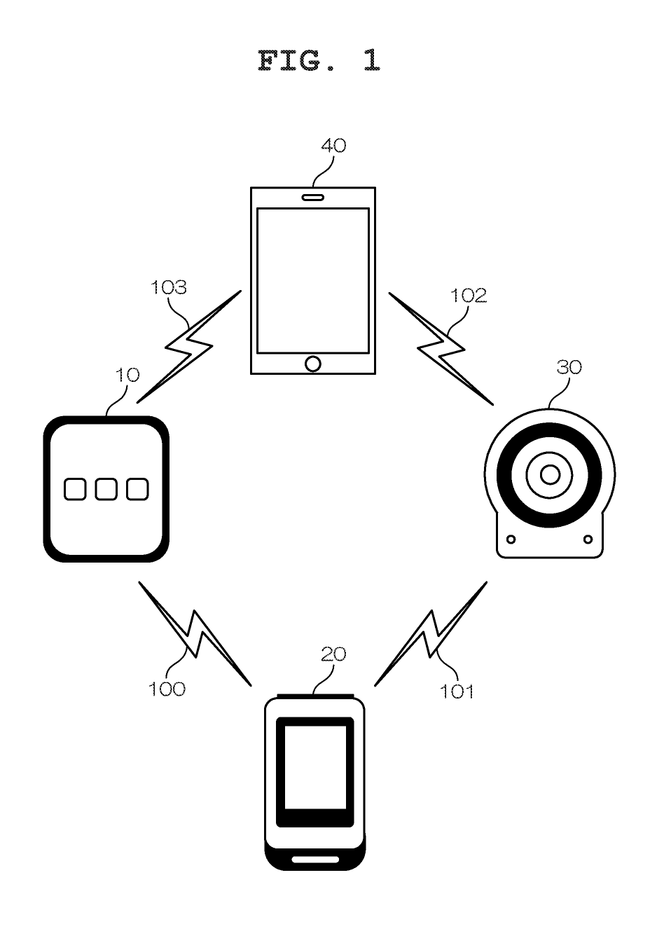

FIG. 1 a block diagram showing the structure of an image transmission system according to an embodiment of the present invention. A sensor unit 10 in FIG. 1 is a portable apparatus that is wearable on the body or clothes of a user. This sensor unit 10 functions as a physical activity meter for a measurement target (subject) carrying the sensor unit 10, which sequentially acquires, as sensor information, the user's biological information (information regarding the user's pulse rate, blood pressure, body temperature, activity amount, and the like); geographic information (position information acquired by positioning by a GPS or the like); external environment information (information regarding altitude, atmospheric pressure, temperature, and the like); and information regarding an impact, a movement, and the like based on data detected by a triaxial acceleration sensor, a gyro sensor, and the like.

Also, the sensor unit 10 performs pairing with a remote controller 20 and a portable wireless communication device 40 at predetermined timing by using wireless communication 100 and 103 (such as a wireless LAN by Bluetooth (registered trademark), WiFi (registered trademark), or the like) which is usable by each of them. When sensor information regarding a movement (motion) of the user, an external environment, or the like satisfies a predetermined imaging condition (imaging factor) set in advance, the sensor unit 10 transmits a recording instruction (to record a still image or a short moving image) for the digital camera 30 to the remote controller 20.

The remote controller 20 performs pairing with the digital camera 30 by using wireless communication 101 (such as a wireless LAN by Bluetooth (registered trademark), WiFi (registered trademark), or the like). When a recording instruction (to record a still image or a short moving image) is received from the sensor unit 10, the remote controller 20 transmits a shutter trigger to the digital camera 30. This remote controller 20 is attachable to and detachable from the digital camera 30, and can be used integrally with or separately from the digital camera 30. Also, this remote controller 20 is not limited to a dedicated terminal and, for example, a smartphone, tablet terminal, or the like can be used as a substitute for it. In this embodiment, as a matter of course, the remote controller 20 is used in a separated state.

The digital camera 30 performs pairing with the remote controller 20 at predetermined timing by using the wireless communication 101 (such as a wireless LAN by Bluetooth (registered trademark), WiFi (registered trademark), or the like. This digital camera 30 can perform interval imaging independently even when connection with the remote controller 20 is in a sleeping or power-saving state (Sniff Mode in Bluetooth (registered trademark)). The interval imaging herein refers to an operation of recording still images or short moving images for a predetermined time at predetermined time intervals.

When a shutter trigger is received from the remote controller 20 at any timing during an operation in an interval imaging mode (recording mode), the digital camera 30 records a still image or a short moving image in accordance with the shutter trigger independently from the operation of the interval imaging mode while continuing this operation of the interval imaging mode (which is, concretely speaking, processing of automatically recording a still image or a short moving image every time a recording instruction, which comes at predetermined time intervals, is detected). Here, the digital camera 30 writes a condition based on which the shutter trigger has been generated (the code of an imaging factor corresponding to one of various data acquired by the sensor unit 10) in the image file as EXIF (Exchangeable Image File Format) information, stores the image file as an unsent image, and continues the interval imaging mode. Then, when the interval imaging mode is ended, the digital camera 30 transmits all image files stored and managed as unsent images to the remote controller 20. Here, image files recorded by the operation of the interval imaging mode are not transferred.

The portable wireless communication device 40 is a device typified by a smartphone, tablet terminal, and the like, and can receive various information services such as a message service and a media content downloading service via an external server and an existing wireless network.

In the present embodiment, the portable wireless communication device 40 is connected to the sensor unit 10 and the digital camera 30 by using wireless communication 103 and 102 by a wireless LAN such as WiFi (registered trademark), and executes application software installed in advance to support the above-described various information services. When connected to the sensor unit 10, the portable wireless communication device 40 performs connection control so as to sequentially receive various sensor information including an imaging factor and store the information in a storage area of a memory of the device managed by the above-described application software.

Also, when connected to the digital camera 30, the portable wireless communication device 40 receives each recorded image file (or each recorded image file whose information amount has been decreased to a predetermined size to decrease its resolution) based on executed contents of the above-described application software and user operations, and stores the information in a storage area of the memory of the device managed by the above-described application software.

Also, as communication control according to the present embodiment, the digital camera 30 performing operations in the interval imaging mode does not transmit the files of images recorded under control in the interval imaging mode to the portable wireless communication device 40. On the other hand, with the end of the interval imaging mode as a trigger, the digital camera 30 transmits to the portable wireless communication device 40 the files of images recorded based on sensor information (imaging factor) transmitted from the sensor unit 10 during the operations in the interval imaging mode (image files stored and managed as the above-described unsent images).

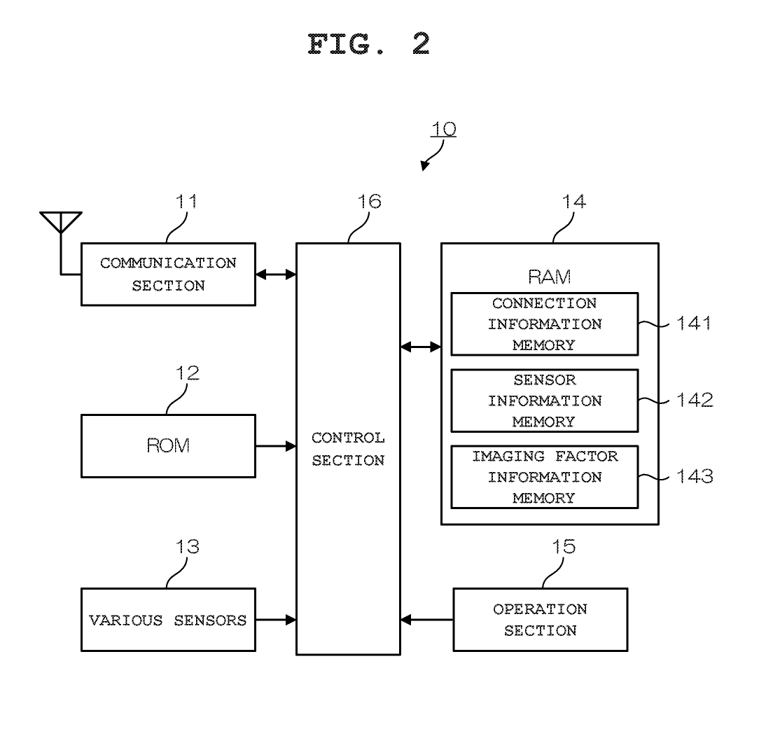

FIG. 2 is a block diagram showing the structure of the sensor unit 10 according to the present embodiment. In FIG. 2, the sensor unit 10 includes a communication section 11, a ROM (Read Only Memory) 12, various sensors 13, a RAM (Random Access Memory) 14, an operation section 15, and a control section 16. The communication section 11 establishes wireless communication with the remote controller 20 and the portable wireless communication device 40 by using a wireless technique such as wireless communication (for example, a wireless LAN by Bluetooth (registered trademark), WiFi (registered trademark), or the like), and thereby transmits or receives data. In the present embodiment, the sensor unit 10 and the remote controller 20 are connected via the wireless communication 100 by Bluetooth (registered trademark). In this embodiment, the sensor unit 10 serves as a slave, and the remote controller 20 serves as a master. On the other hand, the sensor unit 10 and the portable wireless communication device 40 are connected via the wireless communication 103 by Bluetooth (registered trademark) Low Energy and WiFi to transmit and receive sensor information and the like under the control of application software for supporting the above various information services.

Note that, as a communication method, a wireless LAN (Local Area Network), NFC (Near Field Communication), ANT, or the like may be used in addition to the above-described method.

The ROM 12 stores a program to be executed by the control section 16 described later, default values of parameters required along with the execution of this program, and the like. The sensors 13 include a GPS sensor, a motion sensor, a heart rate sensor, a sensor for acquiring an external environment, and the like, and output sensor information at predetermined time intervals.

The RAM 14 is used as a working memory when the control section 16 described later executes the program, and stores various parameters required for the program, operations, and the like to be executed by the control section 16. In particular, in the present embodiment, the RAM 14 includes storage areas of a connection information memory 141 for storing connection information regarding the remote controller 20 and the portable wireless communication device 40 with which pairing has been established, a sensor information memory 142 for storing sensor information detected by the various sensors 13, and an imaging factor information memory 143 for storing imaging factor information set by the user operating the portable wireless communication device 40 to operate application software corresponding to the various information services and transmitted to the remote controller 20. The operation section 15 detects operations by a plurality of mechanical operation keys such as a power supply ON/OFF key and a display switching key, and outputs operation signals in accordance with the user's key operations.

The control section 16 controls the operation of each section by executing the program stored in the above-described ROM 12 and receiving control from the portable wireless communication device 40. In particular, in the present embodiment, the control section 16 derives (calculates) sensor information detected by the various sensors 13 as needed, and stores the information in the sensor information memory 142 as a history.

Also, the control section 16 compares and checks sensor information sequentially stored in the sensor information memory 142 against imaging factor information set in advance by the user and stored in the imaging factor information memory 143. As a result of the check, if any piece of the stored sensor information matches a piece of the imaging factor information, the control section 16 controls the communication section 11 to transmit an occurrence condition (imaging factor) and a recording condition (still image recording instruction or short moving image recording instruction) to the remote controller 20.

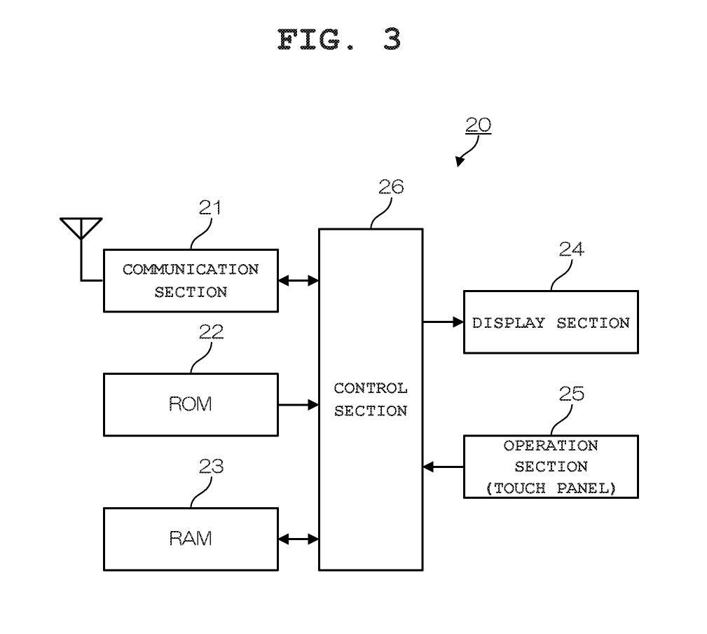

FIG. 3 is a block diagram showing the structure of the remote controller 20 according to the present embodiment. In FIG. 3, the remote controller 20 includes a communication unit (a wireless LAN by Bluetooth (registered trademark), WiFi (registered trademark), or the like) 21, a ROM 22, a RAM 23, a display section 24, an operation section (touch panel) 25, and a control section 26.

The communication section 21 establishes wireless communication between the remote controller 20 and the sensor unit 10 and the digital camera 30 by using a wireless technique such as wireless communication (for example, a wireless LAN by Bluetooth (registered trademark), WiFi (registered trademark), or the like), and thereby transmits or receives data.

The ROM 22 stores a program to be executed by the control section 26 described later, various parameters required for operations and the like, etc. The RAM 23 stores temporary data when the control section 26 described later executes the program.

The display section 24 is constituted by a liquid-crystal display, an organic EL (Electro Luminescence) display, or the like, and displays icons associated with a specific function, application, and the like, an application screen, various menu screens, a live view image from the digital camera 30, an image based on an image file transmitted from the digital camera 30 and temporarily stored in the RAM 35, etc. The operation section (touch panel) 25 detects the direct contact or the approach of a finger, a stylus (pen), or the like. The operation section (touch panel) 25 may include a mechanic switch such as a power supply button and a sound volume button.

The control section 26 controls the operation of each section by executing the program stored in the ROM 22 described above. Also, the control section 26 controls the communication section 21 to transmit an instruction regarding an image capturing mode (still image capturing mode, moving image capturing mode, or interval imaging mode), image capturing parameters (such as exposure, aperture, and shutter speed), a recording instruction by a recording instruction operation (shutter operation) by the user, an instruction for transferring the file of a captured image to the portable wireless communication device 40, and the like. Also, the control section 26 receives a live view image from the digital camera 30 and displays it on the display section 24.

In the present embodiment, the remote controller 20 functions as a relay device between the sensor unit 10 and the digital camera 30. That is, when an occurrence condition (imaging factor) and a recording condition (still image recording instruction or short moving image recording instruction) is received at any timing while the digital camera 30 is being operated in the interval imaging mode, the control section 26 controls the communication section 21 to transmit the occurrence condition (imaging factor) and the recording condition (still image recording instruction or short moving image recording instruction) to the digital camera 30 as a shutter trigger.

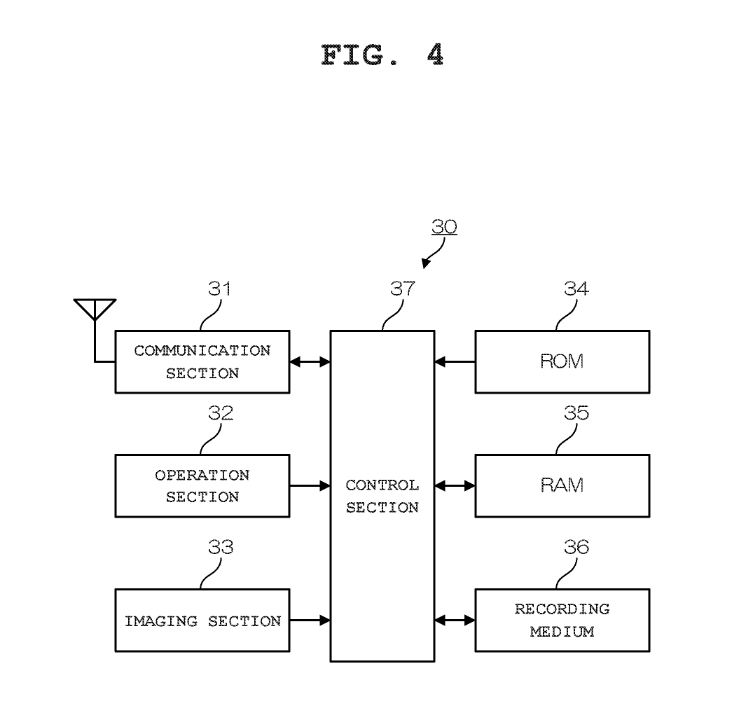

FIG. 4 is a block diagram showing the structure of the digital camera 30 according to the present embodiment. In FIG. 4, the digital camera 30 includes a communication section 31, an operation section 32, an imaging section 33, a ROM 34, a RAM 35, a recording medium 36, and a control section 37. The communication section 31 establishes wireless communication with the remote controller 20 by using a wireless technique such as wireless communication (for example, a wireless LAN by Bluetooth (registered trademark), WiFi (registered trademark), or the like), and thereby transmits or receives data. In the present embodiment, the remote controller 20 serves as a master and the digital camera 30 serves as a slave.

The operation section 32 includes a plurality of operation keys such as a power supply switch, a shutter switch, a zoom switch, a mode key, a SET key, and a cross key, and outputs an operation signal in accordance with the user's key operation. The imaging section 33 is constituted by a lens block formed of an optical lens group and an image sensor such as a CCD (Charge Coupled Device) or CMOS (Complementary Metal Oxide Semiconductor), and converts by the image sensor an image entering from the lens block to a digital signal for output.

The ROM 34 stores a program to be executed by the control section 37 described later and various parameters required for operations and the like. The RAM 35 is used as a buffer memory for temporarily storing the files of images captured by the imaging section 33, and is also used as a working memory for the control section 37. The recording medium 36 stores these image files and the like.

The control section 37 controls the operation of each section by executing the program stored in the ROM 34 described above. In particular, in the present embodiment, the control section 37 sets an operation mode and performs a recording operation by receiving an instruction regarding an image capturing mode (still image capturing mode, moving image capturing mode, or interval imaging mode), image capturing parameters (such as exposure, aperture, and shutter speed), a recording instruction by a recording instruction operation (shutter operation) by the user, an instruction for transferring the file of a captured image, and the like. Also, by detecting a direct operation on the operation section 32, the control section 37 can perform an operation of recording a captured image without receiving the above-described recording instruction from the remote controller 20.

In the present embodiment, when an occurrence condition (imaging factor) and a recording condition (still image recording instruction or short moving image recording instruction) are received as a shutter trigger at any timing from the remote controller 20 while interval imaging is being performed to record still images or a short moving image for a predetermined time at predetermined time intervals, the control section 37 captures a still image or a short moving image in accordance with the shutter trigger independently from the interval imaging, writes the occurrence condition (imaging factor code) in the file of the image as EXIF information, and stores it as an unsent image while continuing the interval imaging mode. After the end of the interval imaging mode (corresponding to a Sleep period), the control section 37 transmits all the files of recorded images stored and managed as unsent images to the portable wireless communication device 40. Note that, here, image files recorded in response to recording instructions related to the interval imaging mode are not transferred.

Note that, although no display section is included in the digital camera 30 of the present embodiment, the digital camera may include a display section constituted by a liquid-crystal display or an organic EL (Electro Luminescence) display, as in the case of a general digital camera.

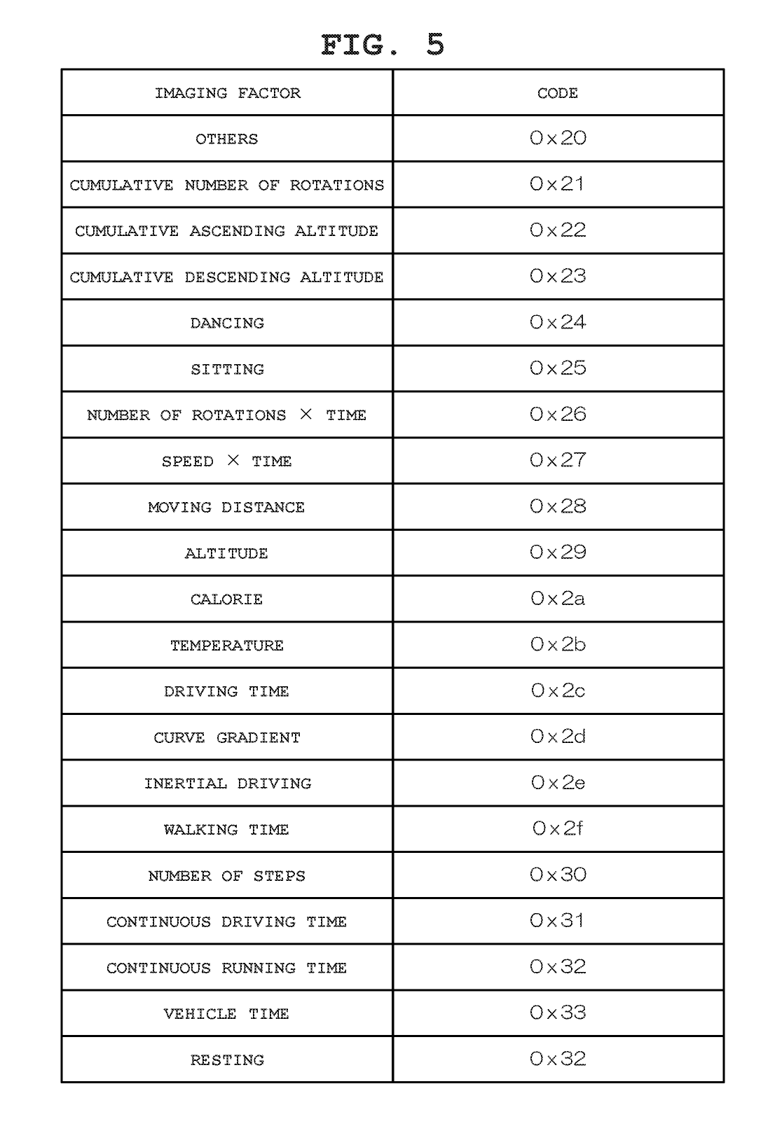

FIG. 5 is a conceptual diagram showing an example of imaging factors that can be set by the sensor unit 10 according to the present embodiment. The imaging factors in the present embodiment include the cumulative number of rotations, cumulative ascending altitude, cumulative descending altitude, dancing, sitting, the number of rotations×time, speed×time, moving distance, altitude, calorie, temperature, driving time, curve gradient, inertial driving, walking time, the number of steps, continuous driving time, continuous running time, vehicle time, and resting. These imaging factors, which are mostly associated with activity details related to outdoor activities (outdoor sports) such as cycling and hiking, are respectively represented by codes “0x20” to “0x32”.

The user specifies (sets) a desired imaging factor from among the above-described imaging factors. In addition, the user specifies (sets) an imaging condition (a threshold value for the imaging factor), and a recording condition. The sensor unit 10 derives (calculates) sensor information regarding a movement (motion) of the user and an external environment detected by the various sensors 13 as needed, and stores the derived information in the sensor information memory 142 of the above-described RAM 14 as a history. Then, every time derived (calculated) sensor information matches the imaging factor information set in advance by the user, the sensor unit 10 transmits an occurrence condition (imaging factor) and a recording condition (still image recording instruction or short moving image recording instruction) to the remote controller 20 by controlling the communication section 11.

As an example, a case is described in which the user selects “moving distance” as an imaging factor, sets 2 km as an imaging condition, and sets a still image recording instruction as a recording condition. In this case, based on information accumulated while the number of vibrations corresponding to the number of steps or the number of rotations of pedals is sequentially accumulated as sensor information, “moving distance” as an occurrence condition (imaging factor) and “still image recording instruction” as a recording condition are transmitted to the remote controller 20 every time the user's moving distance is incremented by 2 km. When an occurrence condition (imaging condition “moving distance”) and a recording condition (still image recording instruction), which are generated at timing at which the moving distance is incremented by 2 km, are received from the remote controller 20 during an operation in the interval imaging mode, the digital camera 30 records a still image unless image acquisition and recording processing in the interval imaging mode is being performed, writes the occurrence condition (code “0x28” of the imaging factor “moving distance”) in the file of this image as EXIF information, and stores it as an unsent image while continuing the operation of the interval imaging mode.

As another example, a case is described in which the user selects “altitude” as an imaging factor, sets 1000 m as an imaging condition, and sets a still image recording instruction as a recording condition. In this case, based on information accumulated while information from a barometer (altimeter) is sequentially accumulated as sensor information, “altitude” as an occurrence condition (imaging factor) and “still image recording instruction” as a recording condition are transmitted to the remote controller 20 every time the altitude of the user's location reaches 1000 m. When an occurrence condition (imaging condition “altitude”) and a recording condition (still image recording instruction), which are generated at timing at which the altitude reaches 1000 m, are received from the remote controller 20 during an operation in the interval imaging mode, the digital camera 30 records a still image unless image acquisition and recording processing in the interval imaging mode is being performed, writes the occurrence condition (code “0x29” of the imaging factor “altitude”) in the file of this image as EXIF information, and stores it as an unsent image while continuing the operation of the interval imaging mode.

As yet another example, a case is described in which the user selects “the number of steps” as an imaging factor, sets 2000 steps as an imaging condition, and sets a short moving image recording instruction as a recording condition. In this case, based on information accumulated while the number of vibrations corresponding to the number of steps is sequentially accumulated as sensor information, “the number of steps” as an occurrence condition (imaging factor) and “short moving image recording instruction” as a recording condition are transmitted to the remote controller 20 every time the number of steps is incremented by 2000. When an occurrence condition (imaging condition “the number of steps”) and a recording condition (short moving image recording instruction), which are generated at timing at which the number of steps is incremented by 2000, are received from the remote controller 20 during an operation in the interval imaging mode, the digital camera 30 records a short moving image unless image acquisition and recording processing in the interval imaging mode is being performed, writes the occurrence condition (code “0x30” of the imaging factor “the number of steps”) in the file of this image as EXIF information, and stores it as an unsent image while continuing the operation of the interval imaging mode.

Note that, although the user selects and sets one imaging factor in the present embodiment, the present invention is not limited thereto and the user may select and set a plurality of imaging factors.

If image acquisition and recording processing in the interval imaging mode is being performed when a shutter trigger, an occurrence condition (imaging factor), and a recording condition (still image recording instruction or short moving image recording instruction) are received from the remote controller 20, the digital camera 30 discards the instruction without recording.

Also, when an imaging factor set in advance by the user from among the above-described imaging factors satisfies a predetermined imaging condition set in advance, the sensor unit 10 transmits this occurrence condition (imaging factor) and a recording condition (still image recording instruction or short moving image recording instruction) to the remote controller 20 by controlling the communication section 11 after a connection with the remote controller 20 is established. Here, it takes a predetermined time (such as five seconds) until a connection between the sensor unit 10 and the remote controller 20 is established. Accordingly, a shutter trigger occurred before a connection between the sensor unit 10 and the remote controller 20 is established is discarded.

### B. Operation of Embodiment

Next, the operation of the above-described embodiment is described.

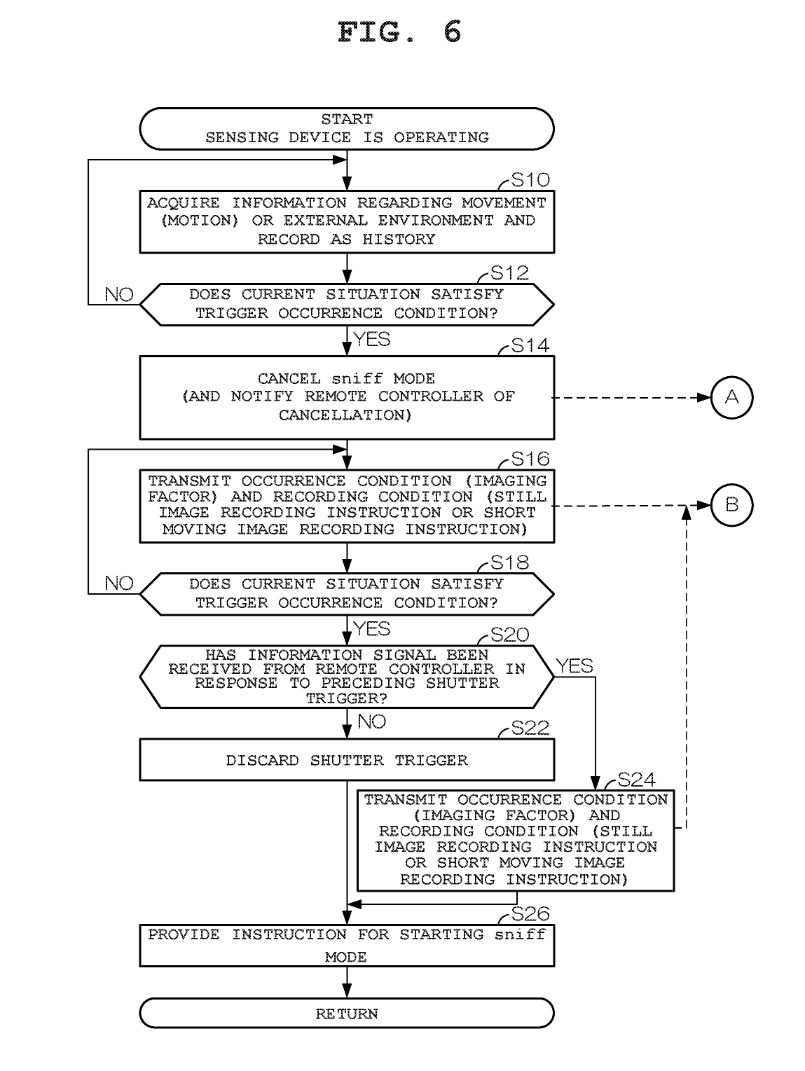

FIG. 6 is a flowchart for describing the operation of the sensor unit 10 according to the present embodiment. Here, the sensor unit 10 has established pairing with the remote controller 20 by using wireless communication (such as a wireless LAN by Bluetooth (registered trademark), WiFi (registered trademark), or the like) and, in the sensor unit 10, the various sensors 13 (sensing devices) are operating. First, the control section 16 derives (calculates) sensor information regarding a movement (motion) of the user and an external environment detected by the various sensors 13 as needed, and stores the sensor information in a predetermined storage area of the above-described RAM 14 as a history (Step S10).

Next, the control section 16 judges, from the history of the sensor information sequentially recorded, whether the current situation satisfies a trigger occurrence condition (Step S12). Here, judging whether the current situation satisfies a trigger occurrence condition is equivalent to judging whether the history of the sensor information indicates a situation that matches an imaging factor set in advance by the user. Then, when judged that the current situation does not satisfy the trigger occurrence condition (NO at Step S12), the control section 16 returns to Step S10 and repeats the operation of deriving (calculating) sensor information as needed and storing the sensor information in the predetermined storage area of the RAM 14.

Conversely, when judged that the history of the sensor information indicates a situation that matches the imaging factor set in advance by the user, that is, the current situation satisfies the trigger occurrence condition (YES at Step S12), the control section 16 cancels the sniff mode (Step S14). Here, the control section 16 notifies the remote controller 20 of the cancellation of the sniff mode. Next, the remote controller 20 transmits the occurrence condition (imaging factor) and a recording condition (still image recording instruction or short moving image recording instruction) as a shutter trigger (Step S16).

Next, the control section 16 again judges whether the current situation satisfies the trigger occurrence condition based on the history of the recorded sensor information (Step S18). This is to judge again whether the imaging factor set in advance satisfies the predetermined imaging condition before a connection between the sensor unit 10 and the remote controller 20 is established (a period of time from when a sniff mode cancelling instruction is provided until when the sniff mode is actually cancelled) as described above.

Then, when judged that the current situation does not satisfy the trigger occurrence condition (NO at Step S18), the control section 16 returns to Step S16.

Conversely, when judged that the current situation satisfies the trigger occurrence condition (YES at Step S18), the control section 16 judges whether an information signal from the remote controller 20 in response to the preceding shutter trigger (at Step S16 herein) has been received (Step S20). Here, receiving an information signal from the remote controller 20 indicates that the remote controller 20 has canceled the sniff mode in response to the sniff-mode release instruction at Step S14 and received the shutter trigger transmitted at Step S16. Conversely, receiving no information signal indicates that the remote controller 20 has not canceled the sniff mode or has not detected the reception of the shutter trigger transmitted at Step S16.

Accordingly, if an information signal has not been received from the remote controller 20 in response to the preceding shutter trigger (NO at Step S20), the cancellation of the sniff mode in the remote controller 20 cannot be confirmed, and there is a possibility of redundant recording instructions if shutter triggers successively occur within a short period of time. Thus, the control section 16 discards the trigger occurrence condition (imaging factor) and the recording condition of Step S18 (Step S22). Next, the control section 16 provides an instruction for restarting the sniff mode (Step S26). Then, the control section 16 ends the processing, and returns to the main routine not shown.

On the other hand, if an information signal has been received from the remote controller 20 in response to the preceding shutter trigger (YES at Step S20), the control section 16 transmits the occurrence condition (imaging factor) and the recording condition (still image recording instruction or short moving image recording instruction) to the remote controller 20, with the satisfaction of the trigger occurrence condition at Step S18 as a factor (Step S24). Next, the control section 16 provides an instruction for starting the sniff mode (Step S26). Then, the control section 16 ends the processing, and returns to the main routine not shown.

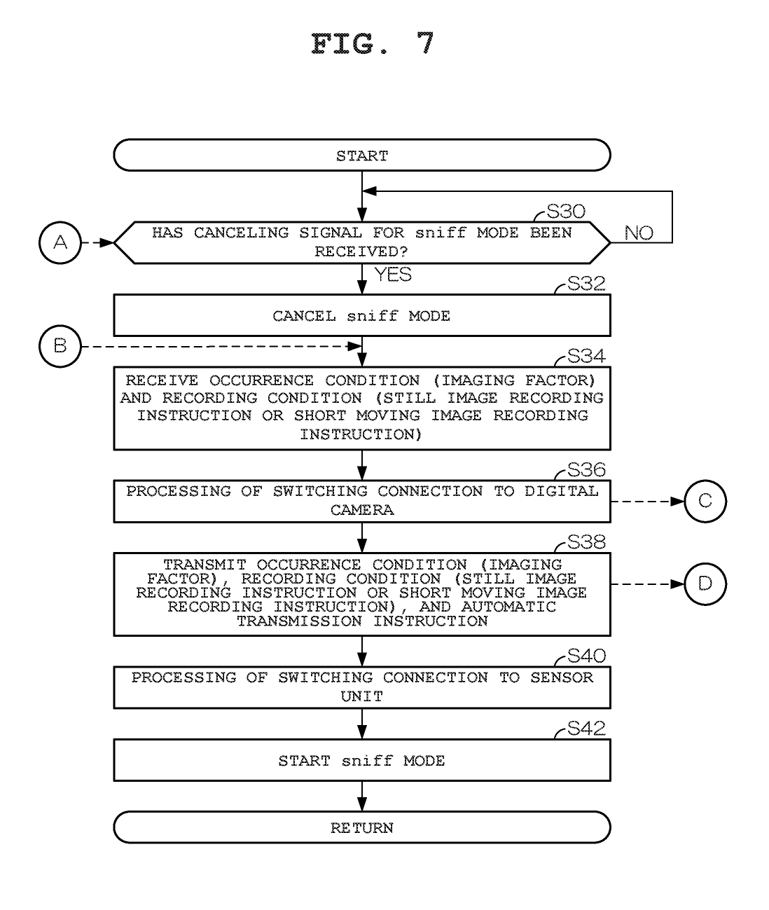

FIG. 7 is a flowchart for describing the operation of the remote controller 20 according to the present embodiment. Here, the remote controller 20 has established pairing with the sensor unit 10 by using wireless communication (such as a wireless LAN by Bluetooth (registered trademark). WiFi (registered trademark), or the like), and is being operated in the sniff mode as a master.

First, the control section 26 judges via the communication section 21 whether a canceling signal for the sniff mode has been received from the sensor unit 10 (Step S30). Then, when the canceling signal has not been received (NO at Step S30), the control section 26 repeatedly performs Step S30.

Conversely, when the canceling signal has been received (YES at Step S30), the control section 26 cancels the sniff mode (Step S32). Next, the control section 26 receives, via the communication section 21, the occurrence condition (imaging factor) and the recording condition (still image recording instruction or short moving image recording instruction) as a shutter trigger transmitted from the sensor unit 10 (Step S34).

Next, the control section 26 performs processing of switching its connection destination from the sensor unit 10 to the digital camera 30 by using wireless communication (such as a wireless LAN by Bluetooth (registered trademark), WIFi (registered trademark), or the like) (Step S36). When the switching to the digital camera 30 is completed, the control section 26 transmits, via the communication section 21, the occurrence condition (imaging factor), the recording condition (still image recording instruction or short moving image recording instruction), and an automatic transmission instruction to the digital camera 30 as a shutter trigger (Step S38).

Next, the control section 26 performs processing of switching its connection destination from the digital camera 30 to the sensor unit 10 by using wireless communication (such as a wireless LAN by Bluetooth (registered trademark), WiFi (registered trademark), or the like) (Step S40). Subsequently, the control section 26 starts the sniff mode (Step S42). Then, the control section 26 ends the processing, and returns to the main routine not shown.

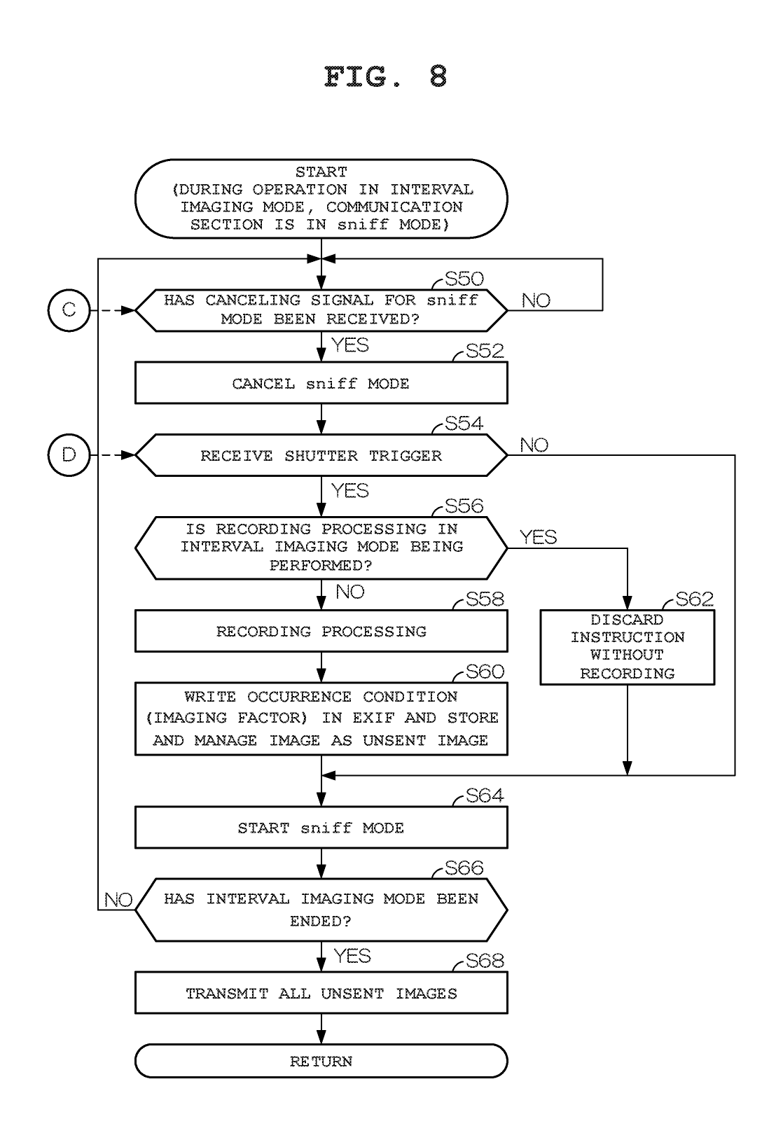

FIG. 8 is a flowchart for describing the operation of the digital camera 30 according to the present embodiment. Here, the digital camera 30 has established pairing with the remote controller 20 by using wireless communication (such as a wireless LAN by Bluetooth (registered trademark), WiFi (registered trademark), or the like). However, the communication section 31 is in the sniff mode. Also, the digital camera 30 is performing an operation in the interval imaging mode as a slave.

First, the control section 37 judges whether the canceling signal has been received from the remote controller 20 (Step S50). When the canceling signal has not been received (NO at Step S50), the control section 37 repeatedly performs Step S50.

Conversely, when the canceling signal has been received (YES at Step S50), the control section 37 cancels the sniff mode (Step S52). Next, the control section 37 judges whether a shutter trigger (an occurrence condition (imaging factor), a recording condition (still image recording instruction or short moving image recording instruction), and an automatic transmission instruction) has been received from the remote controller 20 within a predetermined period of time after the cancellation of the sniff mode (Step S54). Then, when no shutter trigger has been received within the predetermined period of time (NO at Step S54), the control section 37 restarts the operation of the sniff mode (Step S64), and judges whether the interval imaging mode has been ended (Step S66). Then, when the interval imaging mode has not been ended (NO at Step S66), the control section 37 returns to Step S50 to repeat the above-described processing.

Conversely, when a shutter trigger has been received within the predetermined period of time (YES at Step S54), the control section 37 judges whether recording processing in the interval imaging mode is currently being performed (Step S56). Then, if recording processing in the interval imaging mode is not being performed (NO at Step S56), the control section 37 records a still image or a short moving image in accordance with the recording condition (still image recording instruction or short moving image recording instruction) from the remote controller 20 (Step S58). Next, the control section 37 writes the occurrence condition (the code of the imaging factor) in the file of the recorded still image or the recorded short moving image as EXIF information, and stores and manages it as an unsent image (Step S60).

Next, the control section 37 restarts the operation of the sniff mode (Step S64), and judges whether the interval imaging mode has been ended (Step S66). When the interval imaging mode has not been ended (NO at Step S66), the control section 37 returns to Step S50 and repeats the above-described processing.

At Step S56, when recording processing in the interval imaging mode is being performed (YES at Step S56), the control section 37 does not perform recording that is based on the present shutter trigger, and discards the instruction (Step S62). Next, the control section 37 restarts the operation of the sniff mode (Step S64), and judges whether the interval imaging mode has been ended (Step S66). When the interval imaging mode has not been ended (NO at Step S66), the control section 37 returns to Step S50 and repeats the above-described processing.

When the interval imaging mode has been ended (YES at Step S66), the control section 37 transmits all unsent images to the portable wireless communication device 40 (Step S68). More specifically, after the end of the interval imaging mode, the control section 37 transmits all unsent image files immediately before entering a Deep Sleep mode. However, the control section 37 does not transfer image files recorded by recording instructions resulting from the interval imaging mode. Note that, although the files of unsent images are all transmitted with the end of the interval imaging mode as a trigger in the present embodiment, the timing is not limited thereto and a configuration may be adopted in which, every time an image is recorded by the satisfaction of an occurrence condition (imaging factor), this image is automatically transmitted.

Also note that the above-described digital camera 30 starts dedicated application for the portable wireless communication device 40 by, for example, BLE (Bluetooth (registered trademark) Low Energy) and thereby provides an instruction for WiFi (registered trademark) connection. When a WiFi (registered trademark) connection to the portable wireless communication device 40 is established, the digital camera 30 transmits all unsent images to the portable wireless communication device 40.

In the above-described embodiment, when a shutter trigger is received from the sensor unit 10 via the remote controller 20 during an operation in the interval imaging mode, the digital camera 30 executes recording by the imaging section 33 while being operated in the interval imaging mode, and transmits the captured image to the portable wireless communication device 40 at predetermined timing. As a result of this configuration, it is possible to improve convenience in image transmission and check processing that is performed by a shutter trigger occurring under a condition other than that related to the interval imaging mode while continuing the interval imaging mode.

Also, in the above-described embodiment, the digital camera 30 records and manages the file of a recorded image as an unsent image in response to a shutter trigger received at arbitrary timing which is different from a recording instruction for the interval imaging mode, and transmits this unsent image to the portable wireless communication device 40 at the end of the interval imaging mode. As a result of this configuration, it is possible to improve convenience in image transmission and check processing while continuing the interval imaging mode.

Moreover, in the above-described embodiment, the digital camera 30 receives a shutter trigger based on an imaging factor from the sensor unit 10. Accordingly, the user is not required to perform a recording instruction operation. Therefore, it is possible to improve image recording, transmission, and check processing.

While the present invention has been described with reference to the preferred embodiments, it is intended that the invention be not limited by any of the details of the description therein but includes all the embodiments which fall within the scope of the appended claims.

What is claimed is:

1. An image transmission control apparatus comprising:
a communication section;
a detection section which detects a recording instruction signal; and
a control section which controls to perform a recording operation for recording an image when the detection section has detected the recording instruction signal, and controls the communication section as to whether or not to transmit the image to outside of the image transmission control apparatus, based on an occurrence condition of the recording instruction signal.

2. The image transmission control apparatus according to claim 1, wherein the occurrence condition of the recording instruction signal includes at least an occurrence of each recording instruction signal at predetermined time intervals and an occurrence of a recording instruction signal at arbitrary timing.

3. The image transmission control apparatus according to claim 2, wherein recording instruction signals in a specific recording mode occur at the predetermined time intervals, and
wherein the control section, when the occurrence of the recording instruction signal at the arbitrary timing is judged to be the occurrence condition of the recording instruction signal during an operation in the specific recording mode, records an image in response to the recording instruction signal occurred at the arbitrary timing while maintaining the specific recording mode.

4. The image transmission control apparatus according to claim 3, wherein the control section associates the image recorded by detection of the recording instruction signal occurred at the arbitrary timing with information for instructing to transmit to the outside of the image transmission control apparatus, and controls the communication section to transmit the image associated with the information to the outside of the image transmission control apparatus at timing at which recording operations for the specific recording mode are not being performed.

5. The image transmission control apparatus according to claim 2, wherein the recording instruction signal occurred at the arbitrary timing is received by the communication section.

6. The image transmission control apparatus according to claim 2, wherein the recording instruction signal occurred at the arbitrary timing is transmitted from an external device.

7. The image transmission control apparatus according to claim 6, wherein the external device transmits the recording instruction signal occurred at the arbitrary timing in response to detection of a specific movement of the external device.

8. The image transmission control apparatus according to claim 2, wherein the arbitrary timing includes timing at which an environment outside the transmission control apparatus has satisfied a specific condition.

9. The image transmission control apparatus according to claim 8, wherein the recording instruction signal occurred at the arbitrary timing includes information regarding the specific condition.

10. The image transmission control apparatus according to claim 2, wherein the control section controls such that an image recorded by detection of the recording instruction signal at predetermined time intervals is recorded in a recording section in the image transmission control apparatus without being transmitted to the outside of the image transmission control apparatus in response to the recording operation.

11. An image transmission system constituted by an imaging device and an external device, wherein the external device includes a first communication section and a first control section which judges whether an external environment has satisfied a specific condition and controls the first communication section to transmit a recording instruction signal when a judgment is made that the external environment has satisfied the specific condition, and
wherein the imaging device includes an imaging section, a second communication section, and a second control section which (i) judges whether the second communication section has received the recording instruction signal during an operation in a predetermined recording mode, (ii) controls to perform a recording operation for recording an image in response to the recording instruction signal while maintaining the predetermined recording mode, when a judgment is made that the second communication section has received the recording instruction signal, and (iii) controls the second communication section to transmit the recorded image to outside of the imaging device after the recording operation.

12. The image transmission system according to claim 11, wherein the second control section associates the image recorded by detection of the recording instruction signal with information for instructing to transmit to the outside of the apparatus, and controls the second communication section to transmit the image associated with the information to the outside of the imaging device at timing at which recording operations for the specific recording mode are not being performed.

13. The image transmission system according to claim 11, wherein the recording instruction signal includes information regarding the specific condition.

14. The image transmission system according to claim 11, wherein whether the external environment has satisfied the specific condition includes whether the external device has detected a predetermined movement.

15. The image transmission system according to claim 12, wherein the second control section controls such that an image recorded by the specific recording mode is recorded in a recording section in the imaging device without being transmitted to the outside of the imaging device in response to a recording operation.

16. An image transmission control method comprising:
a detection step of detecting a recording instruction signal;
a recording operation step of causing an imaging section to perform a recording operation for recording an image when the recording instruction signal is detected in the detection step; and
a control step of controlling a communication section as to whether or not to transmit the image based on an occurrence condition of the recording instruction signal.

17. A non-transitory computer-readable storage medium having stored thereon a program that is executable by a computer in an image transmission apparatus to actualize functions comprising:
detection processing for detecting a recording instruction signal;
recording operation processing for causing an imaging section to perform a recording operation for recording an image when the recording instruction signal is detected by the detection processing; and
control processing for controlling a communication section as to whether or not to transmit the image based on an occurrence condition of the recording instruction signal.
